(19) United States
(12) Patent Application Publication
(10) Pub. No.: US 2005/0007889 A1
(43) Pub. Date: Jan. 13, 2005

(54) Night light with sleep timer

(76) Inventor: Karin Lynn Peterson, St. Louis, MO (US)

Correspondence Address: Henry W. Cummings, 3313 W. Adams St., St. Charles, MO, 63301, US

(21) Appl. No.: 10/614,245

(22) Filed: Jul. 8, 2003

(51) Int. Cl. G04C 21/16

(52) U.S. Cl. 368/256

(57) ABSTRACT

A timer a light and an optional music source is located on or in a housing of a nightlight assembly. When this assembly is plugged into a source of electric power, the timer is set to a selected time for the light and optional music to remain on. After this selected time has elapsed, the light and music automatically turns off, allowing for sleep in appropriate darkness and silence.

### I FIELD OF THE INVENTION

This invention relates to a nightlight with a sleep timer.

### II BACKGROUND OF THE INVENTION

Many young children prefer the comfort of a nightlight when they go to bed, but their caregivers would prefer them to sleep in darkness. A University of Pennsylvania study, Quinn, G. E., Shin, C. H., Maguire, M. G. and Stone, R. A. Myopia and ambient lighting at night. Nature, 399: 113-114, 1999 (May 13,1999), has shown that children who sleep with a light on may have a higher risk of developing nearsightedness as they get older.

A crib light that shuts off automatically currently exists, but the light goes off after a predetermined time interval of 5 to 10 minutes. Since some children might stay awake for an hour or more after going to bed, the advantage of my nightlight is it allows the caregiver to set the length of time the light is to be on, up to several hours.

In U.S. Pat. No. 5,148,356 the time which the light is on cannot be varied. In U.S. Pat. No. 5,057,051 the extent of illumination can be vareid, but not the time of illumination. In U.S. Pat. No. 6,242,872 a timer, an illuminating device and a socket are disclosed. But this device is much more expensive than the present invention.

### III A OBJECTS OF THE INVENTION

One object of this invention is to allow the child to go to sleep with a night light or music. Another object is to provide structure whereby the the light and or music is turned off after the child has gone to sleep.

### III B. SUMMARY OF THE INVENTION

A timer is located on or adjacent a housing of a nightlight assembly.

When this assembly is plugged into a source of electric currect, the timer is set to a selected time for a light and/or music to remain on. After this selected time has elapsed, the light or music automatically terns off, allowing for sleep in appropriate darkness. The advantage of the nightlight is it allows the caregiver to set the length of time the light and/or music is to be on, up to several hours.

### IV THE DRAWINGS

FIG. 1 is a front view of the nightlight showing the timer.

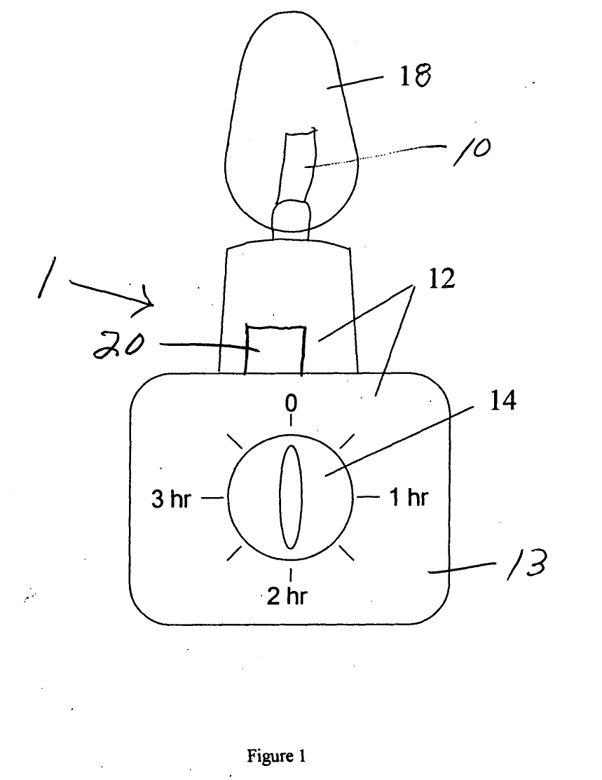

FIG. 2 is a side view of the nightlight showing the electrical prongs.

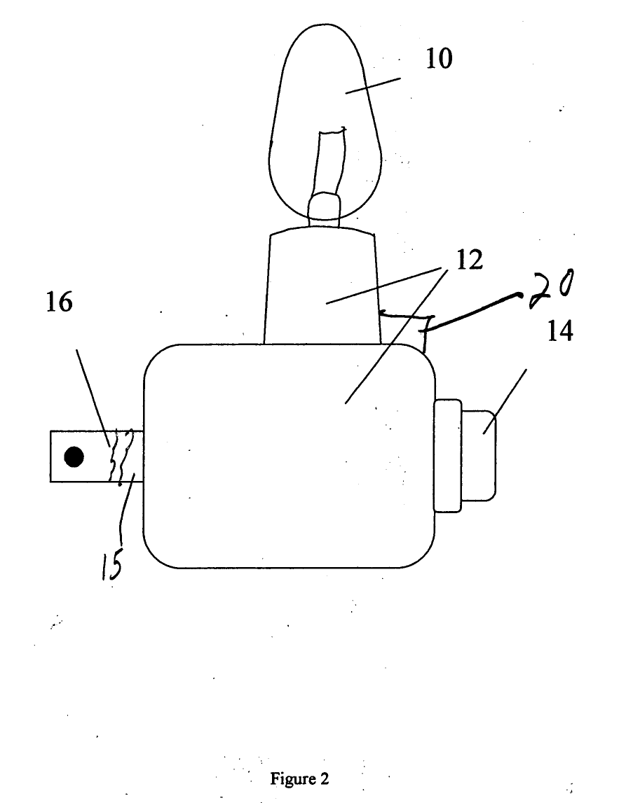

### V DESCRIPTION OF PREFFERRED EMBODIMENTS

The components of the nightlight assembly 1 include the following.

A housing 12 which is preferably formed of molded plastic. A low wattage light bulb 10 fits into the housing 12. A timer 13 includes a knob 14 located on the front of the housing 12. The housing plugs into an electrical outlet (not shown) with an optional electrical cord cord 15 and prongs 16. The arrangement of wiring or connecting the electronic components will be well-known to those with ordinary skill in electronics.

The nightlight assembly 1 achieves its result as follows. When the nightlight is plugged with prongs 16 into an outlet, and the timer knob 14 is turned clockwise to a time, the light turns 10 on. The light 10 turns off after that amount of time has elapsed.

Alternative embodiments of the nightlight with the timer include the following.

The housing 12 may comprise various designs, colors or materials. A cover 18 for the light bulb may be used. The cover may include of various designs, colors or materials. The timer range may be for a longer or shorter period of time. The timer may be be digital. Instead of a low-wattage nightlight 10, a standard wattage bulb and accompanying electronics may be used. The light bulb may be a variety of wattages or sizes or types. The night light assembly may include a source of music 20 such as a a tape, CD or record player to play a lullaby or other music. Electrical prongs 16 may be polarized for safety. While the form of apparatus herein described constitutes a preferred embodiment of the invention, it is to be understood that the invention is not limited to this precise form of apparatus, and that changes may be made therein without departing from the scope of the invention.

1. An night light assembly comprising:
a night light mounted on a housing;
a timer located on said housing adjacent said nightlight;
means for setting the time that said night light will remain on; and
means for connecting said light to a source of electrical power;
whereby when the assembly is plugged into a source of electric current, said timer may be set to a selected time for the light to remain on, and after this selected time has elapsed, said light automatically turns off, allowing for sleep in appropriate darkness.

2 An assembly according to claim 1 wherein said means for connecting said light to a source of electrical power comprise electrical prongs.

3 An assembly according to claim 2 wherein said electrical prongs are polarized for safety.

4 An assembly according to claim 1 wherein said housing comprises decorative designs, colors or materials.

5 An assembly according to claim 1 wherein a cover for said light bulb is provided.

6 An assembly according to claim 5 wherein said cover includes decorative designs, colors or materials.

7 An assembly according to claim 1 wherein said timer is a digital timer.

8 An assembly according to claim 1 wherein said nightlight, comprises a standard wattage bulb.

9 An assembly according to claim 8 wherein said light bulb is provided in a variety of wattages, sizes or types.

10 An assembly according to claim 1 wherein said night light includes means for providing music.

11. An night light assembly comprising:
a night light mounted on a housing;
a timer located on said housing adjacent said nightlight;
means for setting the time that said night light will remain on; and
means for connecting said light to a source of electrical power; and
said night light includes means for providing music,
whereby when the assembly is plugged into a source of electric current, said timer may be set to a selected time for the light and music to remain on, and after this selected time has elapsed, said light and music automatically turn off, for sleep in quiet and darkness.

12 An assembly according to claim 11 wherein said means for connecting said light to a source of electrical power comprise electrical prongs polarized for safety.

13. An night sleeping electrical appliance assembly comprising:
at least one electrical appliance mounted on a housing;
a timer located on said housing adjacent said appliance;
means for setting the time that said appliance will remain on; and
means for connecting said light and/or music source to electrical power;
whereby when the assembly is plugged into a source of electric current, said timer may be set to a selected time for said appliance will remain on, and after this selected time has elapsed, said appliance automatically turns off, for sleep in quiet and darkness.

14 An assembly according to claim 13 wherein said appliance is a source of music

15 An assembly according to claim 14 wherein said source of music comprises a tape player, CD player, or record player.

16 An assembly according to claim 13 wherein said appliance is a light source.

17 An assembly according to claim 13 wherein said two appliances are activated.

18 An assembly according to claim 17 wherein said second appliance is a light source.
